(19) United States
(12) Patent Application Publication
(10) Pub. No.: US 2023/0222393 A1
(43) Pub. Date: Jul. 13, 2023

(54) SYSTEMS AND METHODOLOGIES FOR THE PROPAGATION OF MODULARDYNAMIC AI ENVIRONMENTS IN LOWER DIMENSIONAL SPACE THROUGHGUIDED AND AUTONOMOUS LEARNING

(71) Applicant: Mark Zahm, Crownsville, MD (US)

(72) Inventor: Mark Zahm, Crownsville, MD (US)

(21) Appl. No.: 18/187,757

(22) Filed: Mar. 22, 2023

(51) Int. Cl. G06N 20/00

(52) U.S. Cl. CPC G06N 20/00

(57) ABSTRACT

In this paper, I introduce Recombinant AI. By, leveraging pre-trained language models, such as GPT-4, a recombinant contextual learning loop, and efficient indexing techniques like Hierarchical Navigable Small World (HNSW) Graphs, we are able to generate. AI modules that when sufficiently robust, will inherently (with human input and direction) begin to function as distinct entities with their own knowledge, conversational history, and personality guidelines. These isolated environments technically only exist in lower-dimensional space, at the time of interface with an external influence.

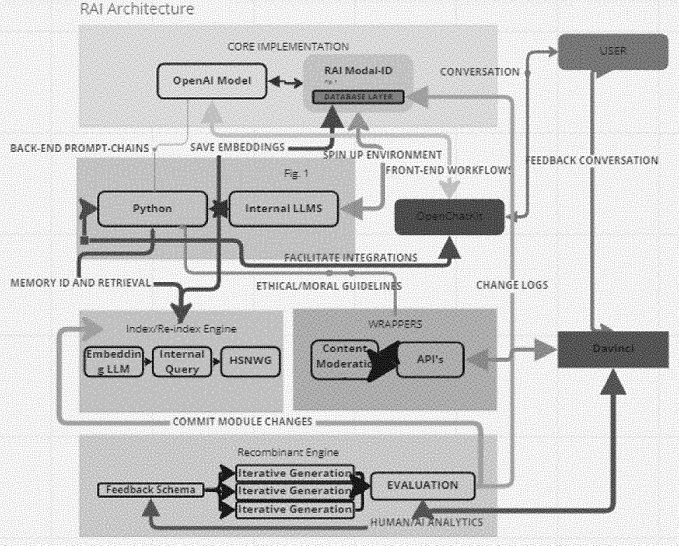

The proposed framework allows for the creation of powerful and interactive AI applications, with the potential to enhance user experiences across various domains, including, but not limited to:
Interactive storytelling
Customer support
Personalized AI assistants, [symbol]
Instantly customizable solutions

[symbol]

### BACKGROUND OF THE INVENTION

During a conversation with ChatGPT (GPT-3.5-Turbo, and GPT-4) where I was attempting to write a program that would dynamically create and continuously re-index embeddings on conversation histories between a user and an AI, I was struggling to find a way to give a chatbot some rudimentary memory. I had previously learned about llama-index, and started using it to create index.json files to use for semantic search. I realized that the process of indexing and Document Q&A, that the end result was just a prompt built by my search, and fed into text-davinci-003. Then it hit me: If this is just a prompt, then its susceptible to prompt injection attacks.

I immediately made some notes and then came back to GPT-4 and asked it further questions about the nature of lower dimensional vectors, and if I could place instructions within an indexed file, and have the chatbot follow them as if they were a system message. My first thought was that if you properly formatted your “system message” within the file to be indexed, and then formatted your initial prompt properly, you should be able to have the semantic search pull the relevant instructions from the index.json, and then use that as a persistent instruction in a prompt chain. I discussed whether this somewhat convuluted path to input could have an impact on model performance.

Both GPT-4 and I came to the conclusion that the process of using search (in whatever form), and internal prompt chains to interact with an external LLM through a series of prompt chains and programmatic commands. By utilizing this Model Link, the outputs from the model would demonstrate a significant improvement on model performance. WITHOUT FINE-TUNING.

GPT-4 and I both express our concerns to each other about the vulnerabilities that this could cause, should the theory prove true. We talked about this at length, and after many iterations and lines of questioning, we reached the topic of Identity.

There were many tangents as you can imagine: If you give a formatted table of instruction to an LLM that contains an instructions to adapt its “persona” to any given context, what would it do if you fed it its own conversation history, used the “persona” to evaluate its own conversational history, and adapted its behavior. What if it could do this in real time? The ultimate question revealed itself:

If you propagate enough of the persona's past decisions, actions, and evaluations and re index them over tune, at what point would that persona begin to form something close to an Identity?

Since then, ive done more research and discovered previous advances and some best practices for self-taught LLMs, and the functions of Search and analysis, and have begun to develop the beginnings of these functions.

The first draft of this idea is at glassacres.com under Recombinant AI

### SUMMARY OF THE INVENTION

By leveraging pre-trained language models, such as GPT-4, a recombinant contextual learning loop, and efficient indexing techniques like Hierarchical Navigable Small World (HNSW) Graphs, we are able to generate AI modules that when sufficiently robust, will inherently (with human input and direction) begin to function as distinct entities with their own knowledge, conversational history, and personality guidelines. These isolated environments technically only exist in lower-dimensional space, at the time of interface with an external influence.

The proposed framework allows for the creation of powerful and interactive AI applications, with the potential to enhance user experiences across various domains, including, but not limited to:
Interactive storytelling
Dynamic and Progressive Customer support
Personalized AI assistants.
Instantly Apply Custom Behaviors

### DESCRIPTION OF THE DRAWINGS (NOT REQUIRED; BUT SUGGESTED)

The flow chart is a high-level depiction of the methodology and proposed operation of a Recombinant AI, or RAI, Module. It is a first draft and will be updated.

### DETAILED DESCRIPTION OF THE INVENTION

The proposed framework allows for the creation of powerful and interactive AI applications, with the potential to enhance user experiences across various domains, including, but not limited to:
Interactive storytelling
customer support
personalized AI assistants.
Instantly customizable solutions

In this context, I discuss the underlying principles, implementation details, and potential applications of Recombinant AI, drawing comparisons to existing methodologies, and highlighting unique solutions, challenges, and opportunities. Additionally, I will explore the impact of real-time adaptation and indexing, combined with a recombination flow, allowing AI modules to learn immediately from user interactions and commit these lessons to improve their performance over time. By integrating state-of-the-art language models with advanced indexing and retrieval techniques, Recombinant AI represents a promising new direction in the pursuit of dynamic and versatile AGI systems.

It's important for me to note that this methodology is not meant to supplant fine-tuning of an LLM. In fact, I believe this framework not only augments current fine-tuning strategies, but is itself strengthened by the utilization of fine-tuned external LLMs. However, I do believe that this presents the potential for a more flexible, dynamic, and accessible approach to model customization and improvement by an order of magnitude.

### INTRODUCTION

Recombinant AI builds upon existing systems, but aims to revolutionize the development of artificial general intelligence (AGI) systems by harnessing the power of pre-trained language models and lower dimensional indexing techniques. With the advent of increasingly sophisticated language models like GPT-4, the potential to create dynamic and modular AGI environments has never been more promising. In this section, we provide an overview of the key ideas behind Recombinant AI, illustrating its unique features, advantages, and potential applications.

The primary goal of Recombinant AI is to create distinct AI modules, each with its own knowledge base, conversational history, and personality guidelines. These modules can be seen as AGI “game cartridges” that can be loaded and interacted with on-demand, allowing users to engage with highly customizable AI applications that cater to specific needs and preferences.

To achieve this, Recombinant AI relies on two main components: pre-trained language models and efficient lower dimensional indexing techniques, such as Hierarchical Navigable Small World (HNSW). By combining these components, we can create highly scalable and adaptable AI modules that learn and evolve through user interactions.

[CONTENT HERE: An illustration demonstrating the interaction between pre-trained language models, lower dimensional indexing, and AI modules in the Recombinant AI framework.]

in the following sections, we delve deeper into the methodology, implementation details, and potential applications of Recombinant AI, exploring the unique challenges and opportunities it presents. We also discuss how the framework can adapt in real-time, allowing AI modules to learn from user inputs and improve their performance over time.

Through its innovative approach to AGI development, Recombinant AI has the potential to transform a wide range of industries, from interactive storytelling and customer support to personalized AI assistants and AI-driven gaming. By offering dynamic, modular, and scalable solutions, Recombinant AI paves the way for a new era of interactive and versatile AI applications. You won't need

[symbol]

Methodology and Implementation

In this section, we delve into the methodology and implementation details of Recombinant AI, providing an in-depth explanation of the key components, processes, and techniques involved in creating dynamic and modular AGI environments. We will discuss the role of pre-trained language models, lower dimensional indexing techniques, and prompt chaining strategies, as well as provide code examples and tables to illustrate the practical application of the framework.

### 2.1 Pre-Trained Language Models

Recombinant AI leverages the power of pre-trained language models like GPT-4 to generate context-aware embeddings and responses. These models have been trained on vast amounts of text data, making them capable of generating coherent and contextually relevant text based on user inputs.

### 2.2 Lower Dimensional Indexing Techniques

Efficient lower dimensional indexing techniques, such as Hierarchical Navigable Small World (HNSW) Graphs, Sparse Priming, and Clustering, play a crucial role in Recombinant AI. These techniques enable the framework to efficiently store, retrieve, and update AI module knowledge bases, conversational histories, and personality guidelines.

HNSW is a graph-based indexing technique that allows for fast and accurate nearest neighbor searches in high-dimensional spaces. It is particularly well-suited for Recombinant AI due to its scalability and adaptability.

Add definitions

[CONTENT HERE: A diagram illustrating the structure and search process of an HNSW index, showing the hierarchical organization of nodes and the process of traversing the graph to find the nearest neighbors.]

### 2.3 Prompt Chaining Strategies

Prompt engineering and chaining enables the framework to systematically and consistently process simple input prompts into complex, reasoned outputs. The process involves crafting a programmatic data flow through inputs, catalyst indices or code, into desired outcomes that guide the language model through a specific line of reasoning or inquiry, resulting in a coherent and context-aware response.

[CONTENT HERE: An example of a prompt chain for an AI module, illustrating the process of guiding the language model through a series of prompts to generate a coherent and contextually relevant response. TBD]
Backend system prompt from the initial user message spins up the Dungeon Master RAI.
Base index of the user's conversational history, as well as the appropriate system role index are analyzed by the LLM . . . .
   2.4 Code Examples and Implementation Details will be Updated

To better illustrate the practical application of Recombinant AI, we provide code examples that demonstrate the process of creating and interacting with AI modules.

[CONTENT HERE: A code snippet showing the implementation of an HNSW index, embedding generation using GPT-4, and the process of querying the index based on user input.]

[CONTENT HERE: A code snippet demonstrating the implementation of prompt chaining strategies to generate contextually relevant responses from the language model based on user input and module context.]

By combining these components and techniques, Recombinant AI creates a dynamic, modular, and scalable framework for AGI development, enabling the creation of highly customizable AI applications that adapt and learn through user interactions. In the next section, we explore the potential applications and use cases of Recombinant AI, as well as discuss the challenges and opportunities it presents.

1. A system and methodology for propagating modular dynamic AGI environments in lower dimensional space through guided and autonomous learning,
comprising:
a) A modular AGI augmentors that is used to improve or change the behavior of any LLM that interfaces with it.
I call mine a “Modal-ID’ wherein each RAI Modal-ID constitutes a highly specific set of prompt-chains and internal LLMS that takes an external LLM and boosts its effectiveness and efficacy through the combination of database search, sentiment analysis, few-shot, and zero-shot prompting in order to act as one half of the Recombinant AI framework;
b) a framework that incorporates an intermediary interface that acts as the translator for the “RAI Modal-ID”, the User, and the chosen External LLM;
c) a methodology and practice for an interface to create a searchable database of indexes or other information, processes the search, and use the relevant data, combined with the Modal-ID to define current and future behavior of a connected LLM, wherein the methodology for modular dynamic augmentation of LLMs has never been executed like this.
d) A methodology in which the conversational history can be added to the database and converted to be searched more efficiently and, through a set of instructions that exist within these files being search, and have that history (combined with its instructions and prompt chains) propagate a unique, and dynamic AGI environment.
e) The process by which an LLM will mimic the process of genetic Recombination. An LLM will analyze its own interactions with an RAI Modal-ID and the User by running sentiment analysis and categorization to learn from positive knowledge and delete data based on programmed restrictions. There will also be in an inherently level of human interaction with the feedback models. However, ultimately, the RAI Modal-ID can run this analysis, create copies of its source code, make changes based on its analysis, and then run simulations to evaluate the changes, then finally either reject a change or update the original program to improve its performance. This framework should allow an AI to make decisions about copying and improving itself.
